(19) United States
(12) Patent Application Publication
(10) Pub. No.: US 2026/0052441 A1
(43) Pub. Date: Feb. 19, 2026

(54) TERMINAL AND RADIO COMMUNICATION METHOD

(71) Applicant: NTT DOCOMO, INC., Tokyo (JP)

(72) Inventor: Tianyang MIN, Tokyo (JP)

(73) Assignee: NTT DOCOMO, INC., Tokyo (JP)

(21) Appl. No.: 19/101,153

(22) PCT Filed: Aug. 5, 2022
(86) PCT No.: PCT/JP2022/030183

§ 371 Date: Feb. 4, 2025

(51) Int. Cl. H04W 36/08; H04W 24/08

(52) U.S. Cl. CPC H04W 36/08; H04W 24/08

(57) ABSTRACT

A terminal controls execution of an addition or change procedure for a secondary cell, and transmits a message to a network when the addition or change procedure succeeds or fails, the message including therein a type of the addition or change procedure, and execution information indicating that the addition or change procedure is initiated by a master node or a secondary node.

### TECHNICAL FIELD

The present disclosure relates to a terminal and a radio communication method that support an addition or change procedure for a secondary cell (secondary node).

### BACKGROUND ART

The 3rd Generation Partnership Project (3GPP: registered trademark) specifies the 5th generation mobile communication system (also referred to as 5G, New Radio (NR) or Next Generation (NG)), and is also promoting next-generation specifications called Beyond 5G, 5G Evolution, or 6G.

For example, in Release 17 of the 3GPP, in order to implement more efficient addition or change of the primary SCell (PSCell), an addition or change procedure (CPAC: conditional PSCell addition/change) for a conditional secondary cell (secondary node) with a simplified procedure is specified. In the conditional PSCell addition/change, an execution condition under which a terminal (user equipment, UE) determines whether to add or change the PSCell can be specified.

In Release 18 of the 3GPP, enhancement of SON (Self-Organising Networks)/MDT (Minimization of Drive Tests) is studied, and CPAC is also a target (Non Patent Literature 1).

### CITATION LIST

### Non Patent Literature

[Non Patent Literature 1] “Further enhancement of data collection for SON (Self-Organising Networks)/MDT (Minimization of Drive Tests) in NR standalone and MR-DC (Multi-Radio Dual Connectivity)”, RP-221825, 3GPP TSG RAN meeting #96, 3GPP, June 2022

### SUMMARY OF INVENTION

CPAC may succeed or fail depending on the quality of PSCell. However, there is a problem in that a network (radio base station, gNB) cannot recognize a situation in which the CPAC succeeds or fails. Therefore, it is difficult to optimize the CPAC in the network.

Therefore, the following disclosure has been made in view of such a situation, and an object thereof is to provide a terminal and a radio communication method that can contribute to optimization of CPAC.

An aspect of the present disclosure is a terminal (UE 200) including: a control unit (control unit 240) that controls execution of an addition or change procedure for a secondary cell; and a transmitting unit (RRC processing unit 220) that transmits a message to a network when the addition or change procedure succeeds or fails, the message including therein a type of the addition or change procedure, and execution information indicating that the addition or change procedure is initiated by a master node or a secondary node.

An aspect of the present disclosure is a radio communication method steps of: executing, by a terminal, an addition or change procedure for a secondary cell; and transmitting, by the terminal, a message to a network when the addition or change procedure succeeds or fails, the message including therein a type of the addition or change procedure, and execution information indicating that the addition or change procedure is initiated by a master node or a secondary node.

### BRIEF DESCRIPTION OF DRAWINGS

FIG. 1 is an overall schematic configuration diagram of a radio communication system 10.

FIG. 2 is a functional block configuration diagram of an eNB 100A and a gNB 100B.

FIG. 3 is a functional block configuration diagram of a UE 200.

FIG. 4 is a diagram illustrating a CPAC failure report sequence example (using SCGFailureInfo) according to a first operation example.

FIG. 5 is a diagram illustrating a CPAC failure report sequence example (using UE information response) according to the first operation example.

FIG. 6 is a diagram illustrating a CPAC success report sequence example (using SCGSuccessInfo) according to a second operation example.

FIG. 7 is a diagram illustrating a CPAC success report sequence example (using UE information response) according to the second operation example.

FIG. 8 is a diagram illustrating an example of a hardware configuration of each of the eNB 100A, the gNB 100B, and the UE 200.

FIG. 9 is a diagram illustrating a configuration example of a vehicle 2001.

### MODES FOR CARRYING OUT THE INVENTION

Hereinafter, embodiments will be described with reference to the drawings. It is noted that the same functions and configurations are denoted by the same or similar reference numerals, and the description thereof will be appropriately omitted.

### (1) Overall Schematic Configuration of Radio Communication System

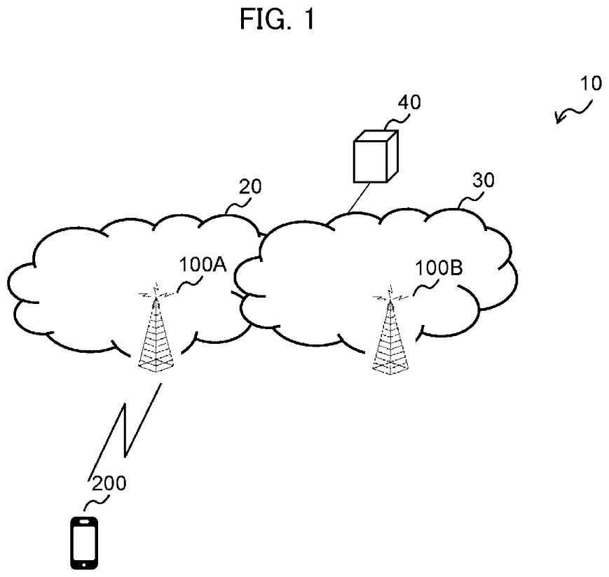

FIG. 1 is an overall schematic configuration diagram of a radio communication system 10 according to the present embodiment. The radio communication system 10 is a radio communication system according to Long Term Evolution (LTE) and 5G New Radio (NR). It is noted that LTE may be referred to as 4G, and NR may be referred to as 5G. Furthermore, the radio communication system 10 may be a radio communication system according to a system called Beyond 5G, 5G Evolution, or 6G.

LTE and NR may be interpreted as a radio access technology (RAT), and in the present embodiment, LTE may be referred to as a first radio access technology, and NR may be referred to as a second radio access technology.

The radio communication system 10 includes an Evolved Universal Terrestrial Radio Access Network 20 (hereinafter, referred to as E-UTRAN 20) and a Next Generation-Radio Access Network 30 (hereinafter, referred to as NG RAN 30). In addition, the radio communication system 10 includes a terminal 200 (UE 200, User Equipment).

The E-UTRAN 20 includes an eNB 100A which is a radio base station according to LTE. The NG RAN 30 includes a gNB 100B which is a radio base station according to 5G (NR). Furthermore, a User Plane Function (UPF 40) or the like that is included in a 5G system architecture and provides a user plane function may be connected to the NG RAN 30.

It is noted that the E-UTRAN 20 and the NG RAN 30 (which may be the eNB 100A and the gNB 100B) may be simply referred to as a network. Furthermore, a specific configuration of the radio communication system 10 including the number of each of eNBS, gNBs, and UEs is not limited to the example illustrated in FIG. 1.

The eNB 100A, the gNB 100B, and the UE 200 can support carrier aggregation (CA) using a plurality of component carriers (CCS), dual connectivity in which component carriers are simultaneously transmitted between a plurality of NG-RAN Nodes and the UE, and the like.

The eNB 100A, the gNB 100B, and the UE 200 perform radio communication via a radio bearer, specifically, a Signaling Radio Bearer (SRB) or a DRB Data Radio Bearer (DRB).

In the present embodiment, Multi-Radio Dual Connectivity (MR-DC) in which the eNB 100A configures a master node (MN) and the gNB 100B configures a secondary node (SN), specifically, E-UTRA-NR Dual Connectivity (EN-DC) may be executed, or NR-E-UTRA Dual Connectivity (NE-DC) in which the gNB 100B configures the MN and the eNB 100A configures the SN may be executed. Alternatively, NR-NR Dual Connectivity (NR-DC) in which gNBs configures the MN and the SN may be executed.

As described above, the UE 200 supports dual connectivity in which the UE 200 is connected to the eNB 100A and the gNB 100B.

The eNB 100A may be included in a master cell group (MCG), and the gNB 100B may be included in a secondary cell group (SCG). That is, the gNB 100B is an SN included in the SCG. It is noted that, as described above, NE-DC or the like may be used, and for example, the gNB 100B may be the MN, and the eNB 100A may be the SN.

The eNB 100A and the gNB 100B may be referred to as radio base stations or network devices.

Furthermore, in the radio communication system 10, conditional addition or change (conditional PSCell addition/change, CPAC) of the Primary SCell (PSCell) may be supported. The PSCell is a type of secondary cell. The PSCell means a primary SCell (secondary cell), and may be interpreted as corresponding to any SCell of a plurality of SCells.

It is noted that the secondary cell may be read as a secondary node (SN) or a secondary cell group (SCG). The conditional PSCell addition/change may implement efficient and quick addition or change of the secondary cell.

The conditional PSCell addition/change may be interpreted as an addition or change procedure for the conditional secondary cell in which the procedure is simplified. In addition, the conditional PSCell addition/change may mean at least one of addition (addition, CPA) or change (change, CPC) of the SCell.

In addition, the radio communication system 10 may support a conditional inter-SN PSCell change procedure. Specifically, MN-initiated conditional PSCell change on the MN initiative and/or SN-initiated conditional PSCell change on the SN initiative may be supported.

Further, in the radio communication system 10, an SN initiated inter-SN CPC procedure which is an SN initiated CPC between SNs and/or an SN initiated intra-SN CPC procedure which is an SN initiated CPC in the same SN may be supported as the conditional PSCell change (CPC). The SN initiated inter-SN CPC procedure may be referred to as SN initiated conditional inter-SN Change.

### (2) Functional Block Configuration of Radio Communication System

Next, a functional block configuration of the radio communication system 10 will be described. Specifically, functional block configurations of the eNB 100A, the gNB 100B, and the UE 200 will be described.

### (2.1) eNB 100A and gNB 100B

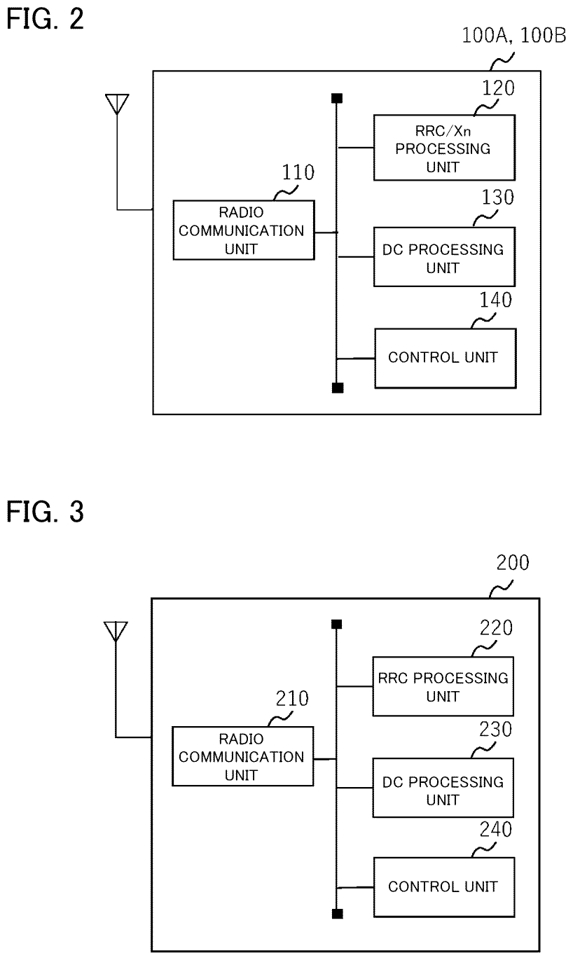

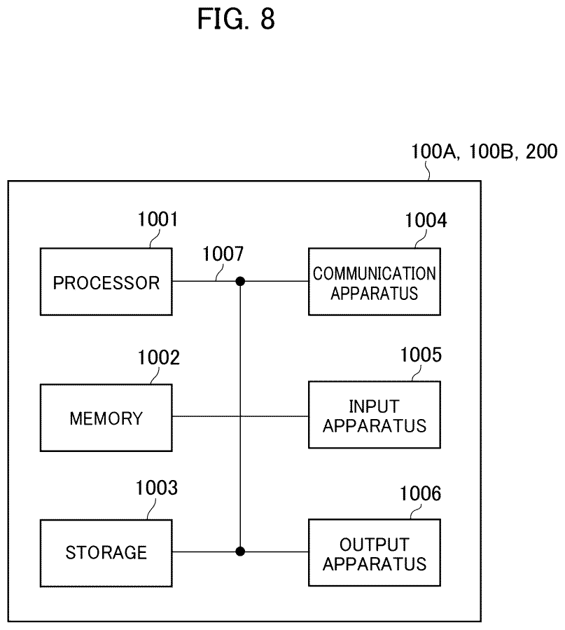

FIG. 2 is a functional block configuration diagram of each of the eNB 100A and the gNB 100B. As illustrated in FIG. 2, each of the eNB 100A and the gNB 100B includes a radio communication unit 110, an RRC/Xn processing unit 120, a DC processing unit 130, and a control unit 140. It is noted that, in FIG. 2, only main functional blocks related to the description of the embodiment are illustrated, and each of the eNB 100A and the gNB 100B has other functional blocks (for example, a power supply unit or the like). Furthermore, FIG. 2 illustrates a functional block configuration of each of the eNB 100A and the gNB 100B, and a hardware configuration thereof is described with reference to FIG. 8.

The radio communication unit 110 transmits a downlink signal (DL signal) according to a predetermined radio system (LTE or NR). In addition, the radio communication unit 110 receives an uplink signal (UL signal) according to a predetermined radio system (LTE or NR).

The RRC/Xn processing unit 120 executes various processes related to a radio resource control layer (RRC) and an Xn interface. Specifically, the RRC/Xn processing unit 120 can transmit RRC Reconfiguration to the UE 200. In addition, the RRC/Xn processing unit 120 can receive RRC Reconfiguration Complete, which is a response to the RRC Reconfiguration, from the UE 200.

In addition, the RRC/Xn processing unit 120 can receive information related to SCG from the UE 200. Specifically, the RRC/Xn processing unit 120 can receive SCGFailureInfo, which is a message including information regarding a failure of the SCG, from the UE 200. Alternatively, the RRC/Xn processing unit 120 can receive SCGSuccessInfo, which is a message including information regarding normal operation of the SCG, from the UE 200. SCGSuccessInfo is a provisional name, and may be any name as long as it means that the conditional PSCell addition/change (CPAC) is normally completed (succeeded).

In addition, the RRC/Xn processing unit 120 can transmit, to the UE 200, a UE information request for requesting the UE 200 to transmit information, and can receive, from the UE 200, a UE information response returned from the UE 200 with respect to the UE information request.

It is noted that, in the present embodiment, the eNB 100A supports LTE, but in this case, the name of the RRC message may be RRC Connection Reconfiguration or RRC Connection Reconfiguration Complete.

In addition, in the case of a radio base station supporting LTE (Evolved Universal Terrestrial Radio Access Network (E-UTRAN)), an X2 interface may be used instead of an Xn. Alternatively, the Xn and the X2 interfaces may be used in combination. Hereinafter, the Xn interface will be described as an example.

The RRC/Xn processing unit 120 can transmit and receive inter-node messages via the Xn interface. For example, in a case of configuring the secondary node (SN), the RRC/Xn processing unit 120 may receive a message related to the SCell (may include the PSCell, the same applies below) from another radio base station, specifically, the master node (MN).

More specifically, the RRC/Xn processing unit 120 of the SN constituting a source secondary node (S-SN) may receive an SN Addition Request from the MN. Furthermore, the RRC/Xn processing unit 120 may return an SN Addition Request Ack to the MN on the basis of reception of the SN Addition Request.

Further, the RRC/Xn processing unit 120 of the S-SN may transmit SN Status Transfer to a target secondary node (T-SN).

The SN Status Transfer may include a count value (count) of a first downlink (DL) Service Data Unit (SDU) transferred by the S-SN to the T-SN, or a count value for discarding a DL SDU already transferred in each data radio bearer (DRB). It is noted that a Protocol Data Unit (PDU) may be used instead of the SDU.

The RRC/Xn processing unit 120 of the SN constituting the S-SN may transmit (transfer) the SN Status Transfer to the T-SN via the MN. Alternatively, the RRC/Xn processing unit 120 of the SN constituting the S-SN may directly transmit the SN Status Transfer to the T-SN without passing through the MN, or may transmit the SN Status Transfer in parallel to the MN and the T-SN.

On the other hand, in the case of configuring the MN, the RRC/Xn processing unit 120 may receive a message related to addition or change of the SCell from the SN. The RRC/Xn processing unit 120 may receive a message related to an addition of the SCell and a message related to a change of the SCell.

More specifically, the RRC/Xn processing unit 120 may receive SN change required and/or SN Addition Request Ack from the SN.

In addition, the RRC/Xn processing unit 120 may transmit and receive an inter-node message including contents related to failure (abnormal end) or success (normal end) of the CPAC. Specifically, the RRC/Xn processing unit 120 constituting the MN may transmit an SCG failure information report or an SCG success information report to the SN.

The DC processing unit 130 executes processing related to dual connectivity, specifically, Multi-RAT Dual Connectivity (MR-DC). In the present embodiment, since the eNB 100A supports LTE and the gNB 100B supports NR, the DC processing unit 130 may execute processing related to E-UTRA-NR Dual Connectivity (EN-DC). It is noted that the type of DC is not limited as described above, and for example, NR-E-UTRA Dual Connectivity (NE-DC) or NR-NR Dual Connectivity (NR-DC) may be supported.

The DC processing unit 130 can transmit and receive a message specified in the 3GPP TS37.340 or the like and execute processing related to DC configuration and release between the eNB 100A, the gNB 100B, and the UE 200.

The control unit 140 controls each functional block constituting the eNB 100A. In particular, in the present embodiment, control related to addition or change of the secondary node is executed.

The control unit 140 controls an addition or change procedure for the SCell, particularly, execution of the conditional PSCell addition/change. Specifically, the control unit 140 can execute addition (addition, CPA) or change (change, CPC) of the SCell in cooperation with the SN (or the MN) on the basis of an execution condition.

Furthermore, the control unit 140 may change the configuration related to the CPAC on the basis of the SCGFailureInfo or the SCGSuccessInfo received by the RRC/Xn processing unit 120. When the CPAC fails (abnormally ends) or succeeds (normally ends), the SCGFailureInfo or the SCGSuccessInfo may include information regarding the CPAC (which may be referred to as execution information). Details of the information regarding the CPAC will be described later.

It is noted that, in the present embodiment, the channel includes a control channel and a data channel. The control channel includes a Physical Downlink Control Channel (PDCCH), a Physical Uplink Control Channel (PUCCH), a Physical Random Access Channel (PRACH), a Physical Broadcast Channel (PBCH), and the like.

In addition, the data channel includes a Physical Downlink Shared Channel (PDSCH), a Physical Uplink Shared Channel (PUSCH), and the like.

It is noted that a reference signal includes a Demodulation reference signal (DMRS), a Sounding Reference Signal (SRS), a Phase Tracking Reference Signal (PTRS), a Channel State Information-Reference Signal (CSI-RS), and the like, and the signal includes a channel and a reference signal. In addition, the data may mean data transmitted via the data channel.

### (2.2) UE 200

FIG. 3 is a functional block configuration diagram of the UE 200. As illustrated in FIG. 3, the UE 200 includes a radio communication unit 210, an RRC processing unit 220, a DC processing unit 230, and a control unit 240. It is noted that, in FIG. 3, only main functional blocks related to description of the embodiments are illustrated, and the UE 200 has other functional blocks (for example, a power supply unit or the like). In addition, FIG. 3 illustrates a functional block configuration of the UE 200, and a hardware configuration thereof is described with reference to FIG. 8.

The radio communication unit 210 transmits an uplink signal (UL signal) according to LTE or NR. In addition, the radio communication unit 210 receives a downlink signal (DL signal) according to LTE or NR. That is, the UE 200 can access the eNB 100A (E-UTRAN 20) and the gNB 100B (NG RAN 30), and can support dual connectivity (specifically, EN-DC).

The RRC processing unit 220 executes various processes in a radio resource control layer (RRC). Specifically, the RRC processing unit 220 can transmit and receive a message of the radio resource control layer.

In the present embodiment, the RRC processing unit 220 can transmit SCGFailureInfo, which is a message including information regarding a failure of the SCG, or SCGSuccessInfo, which is a message including information regarding a normal operation of the SCG, to a network (specifically, the eNB 100A or the gNB 100B). It is noted that both the SCGFailureInfo and the SCGSuccessInfo may be transmitted, or only one of them may be transmitted.

In addition, the RRC processing unit 220 can transmit, to the network, a UE information response which is a response message to a UE information request for requesting the UE 200 to transmit information.

When CPAC succeeds or fails, the RRC processing unit 220 can transmit, to the network, a message (SCGFailureInfo/SCGSuccessInfo, UE information response) including the type of CPAC and information (execution information) indicating that the master node (MN) or the secondary node (SN) has initiated CPAC. In the present embodiment, the RRC processing unit 220 constitutes a transmitting unit.

The information regarding the failure of the CPAC may be referred to as a CPAC failure info. The information regarding the success of the CPAC may be referred to as a PSCell change success info (or a successful PSCell change report). It is noted that the CPAC failure info and the PSCell change success info are provisional names, and may be referred to as other similar names.

The type of CPAC may be either CPA or CPC, and the information indicating that the MN or the SN has initiated the CPAC may be an indication that can distinguish MN initiated CPA/CPC or SN initiated CPC. It is noted that the CPAC may be referred to as conditional reconfiguration.

When the CPAC fails, the RRC processing unit 220 may transmit the message including an execution condition of the CPAC associated with a secondary cell (PSCell) in which the CPAC fails. Specifically, the execution condition may include condeventA3, condeventA4, condeventA5, condEventD1, condEventT1, and the like specified in 3GPP TS38.331. Alternatively, the RRC processing unit 220 may transmit the message including identification information (CondReconfigId) of a conditional reconfiguration associated with the PSCell.

The RRC processing unit 220 may transmit the message including the elapsed time from the start of the CPAC. Specifically, timeSinceCPACReconfig (provisional name) may be included in the message. timeSinceCPACReconfig may indicate an elapsed time from reception of the latest configuration content of a conditional reconfiguration to start of execution of an immediately preceding conditional reconfiguration for a transition destination PSCell (target PSCell). In the case of an SCG radio link failure (RLF), timeSinceCPACReconfig may indicate an elapsed time from the SCG radio link failure to reception of the latest conditional reconfiguration.

The RRC processing unit 220 may transmit the message including identification information of the UE 200. Specifically, a Cell Radio Network Temporary Identifier (C-RNTI) may be included in the message. The C-RNTI may be set for the UE 200 by the MN or may be set for the UE 200 by the SN. It is noted that information that can uniquely identify the UE 200, such as another RNTI (for example, TC-RNTI), may be used instead of the C-RNTI.

When the CPAC fails, the RRC processing unit 220 may transmit the message including information of candidate secondary cells (candidate PSCells) other than the secondary cell (PSCell) in which the CPAC fails. Specifically, CondReconfigId associated with the candidate PSCell may be included in the message. It is noted that information other than CondReconfigId (Physical Cell ID (PCI) or the like) may be used as long as the information can identify the candidate PSCell.

When the CPAC is successful, the RRC processing unit 220 may transmit the message according to the setting of whether transmission of the PSCell change success info (execution information) is necessary. Specifically, the RRC processing unit 220 may transmit the SCGSuccessInfo in a case where transmission of the SCGSuccessInfo including the PSCell change success info is instructed by signaling from a network in RRC, another layer, or a previous configuration. It is noted that whether transmission of the PSCell change success info is necessary may be read as whether transmission of the SCGSuccessInfo is necessary.

The DC processing unit 230 executes processing related to dual connectivity, specifically, MR-DC. As described above, in the present embodiment, the DC processing unit 230 may execute processing related to the EN-DC, but may support the NE-DC and/or the NR-DC.

The DC processing unit 230 can access each of the eNB 100A and the gNB 100B and execute setting in a plurality of layers (a media access control layer (MAC), a radio link control layer (RLC), a packet data convergence protocol layer (PDCP), and the like) including RRC.

The control unit 240 controls each functional block constituting the UE 200. In particular, in the present embodiment, the control unit 240 controls execution of the conditional PSCell addition/change.

Specifically, the control unit 240 can control execution of the conditional PSCell addition/change (addition or change procedure) of the secondary cell (specifically, the PSCell).

Specifically, the control unit 240 may monitor the execution condition of the conditional PSCell addition/change and determine whether there is a target PSCell that satisfies the execution condition. When there is a target PSCell that satisfies the execution condition, the control unit 240 may apply RRC reconfiguration of the target PSCell and return RRC Reconfiguration Complete to the MN.

### (3) Operation of Radio Communication System

Next, an operation of the radio communication system 10 will be described. Specifically, an operation of the radio communication system 10 related to an addition or change procedure (conditional PSCell addition/change) of a conditional secondary cell (secondary node) will be described.

### (3.1) Premise and Problem

As described above, the radio communication system 10 can support the MR-DC and support the conditional PSCell addition/change (CPAC). The CPAC may succeed or fail depending on the communication state with the candidate PSCell, that is, the quality of the candidate PSCell.

In the following operation examples, an object is to optimize the CPAC by enabling a network to recognize information regarding failure (abnormal end) or success (normal end) of the CPAC by the UE 200.

Specifically, in the following operation examples, when the CPA or the CPC in the MR-DC fails, information regarding the failure is reported. In addition, in a case where the CPA or the CPC in the MR-DC succeeds, information regarding the success is reported.

### (3.2) First Operation Example

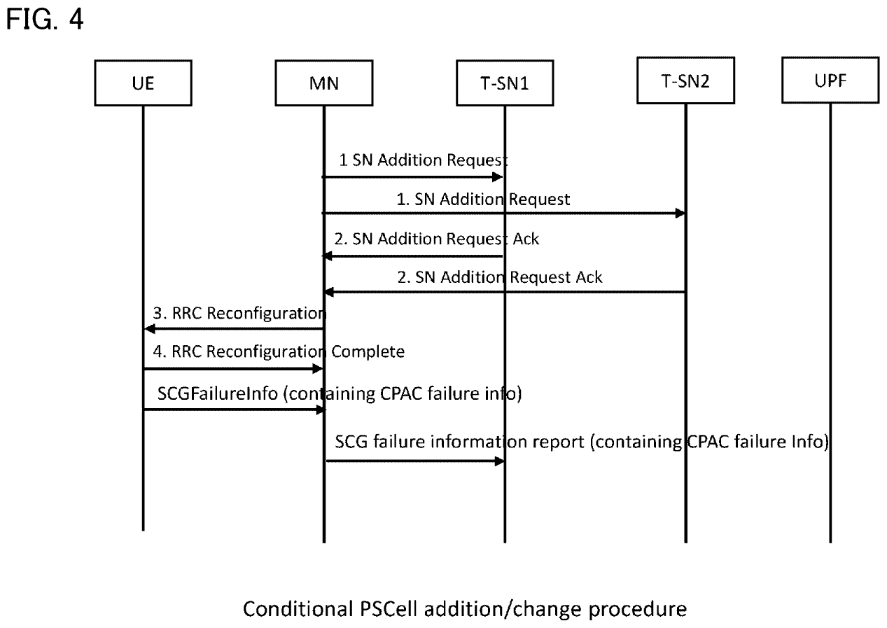

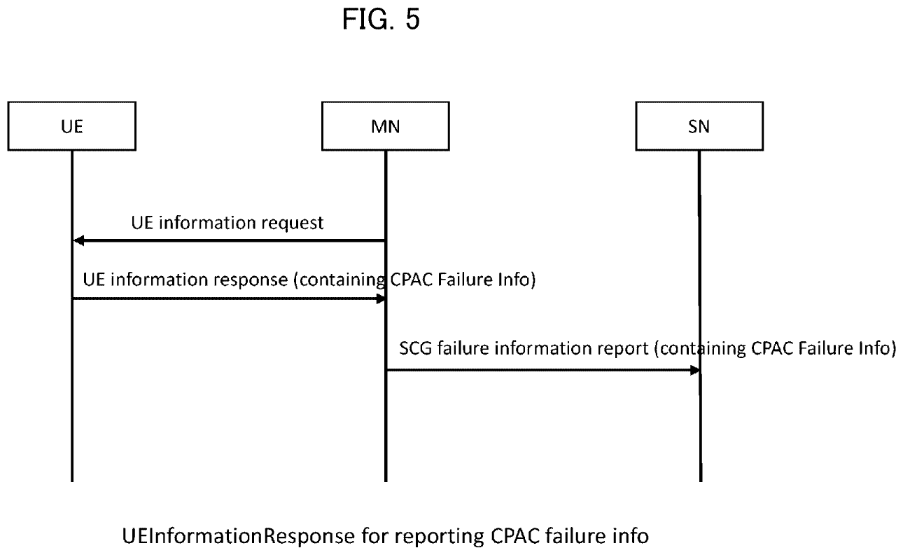

FIG. 4 illustrates an example of a CPAC failure report sequence (using SCGFailureInfo) according to a first operation example. FIG. 5 illustrates an example of a CPAC failure report sequence (using UE information response) according to the first operation example.

As illustrated in FIGS. 4 and 5, the UE 200 may transmit SCGFailureInfo or UE information response including CPAC failure info to the network, specifically, the MN. As illustrated in FIG. 4, the SCGFailureInfo may be transmitted after receiving RRC Reconfiguration Complete or after transmitting RACH. In addition, FIG. 4 illustrates an example of a case in which PSCell formed by T-SN1 is accessed but connection fails. A transmission timing of a UE information request illustrated in FIG. 5 may be arbitrarily determined by the MN.

The CPAC failure info may include the following information (execution information).

Indication that Can Distinguish MN Initiated CPA/CPC or SN Initiated CPC

For example, the type of execution condition associated with the PSCell in which the CPA or CPC fails may be included. Specifically, an indication that is set by condExecutioncond (refer to 3GPP TS38.331) or that is set in condExecutionCondSCG may be included.

The condExecutioncond may be interpreted as an execution condition that needs to be satisfied to trigger execution of the conditional reconfiguration. The condExecutionCondSCG may be interpreted as an execution condition that needs to be satisfied to trigger execution of the conditional reconfiguration of inter-SN CPC initiated by the SN.

Execution Condition Associated with Cell in Which CPAC Fails

Specifically, condeventa3, condeventa4, condeventa5, condEventD1, condEventT1 (refer to 3GPP TS38.331) may be included. The condeventA3, the condeventA4, the condeventA5, the condEventD1, and the condEventT1 may be defined as follows.
CondEvent A3: Conditional reconfiguration candidate becomes amount of offset better than PCell/PSCell;
CondEvent A4: Conditional reconfiguration candidate becomes better than absolute threshold;
CondEvent A5: PCell/PSCell becomes worse than absolute threshold1 AND Conditional reconfiguration candidate becomes better than another absolute threshold2;
CondEvent D1: Distance between UE and a reference location referenceLocation1 becomes larger than configured threshold distanceThreshFromReference1 and distance between UE and a reference location referenceLocation2 of conditional reconfiguration candidate becomes shorter than configured threshold distanceThreshFromReference2;
CondEvent T1: Time measured at UE becomes more than configured threshold t1-Threshold but is less than t1-Threshold+duration;

Alternatively, CondReconfigId associated with a cell in which the CPAC has failed may be included. The MN may determine, based on the reported CondReconfigId, that the condExecutioncond or the condExecutionCondSCG has been set.

CondReconfigId Associated with Unexecuted Candidate PSCell(s)

In the case of the MN initiated CPA/CPC, since the measurement by the UE 200 is set by the MN, the MN may optimize the CPAC based on SCGFailureInfo (or UE information response). In the case of the SN initiated CPC, since the measurement by the UE 200 is set by the SN, the CPAC failure info is transmitted from the MN to the SN via Xn-AP, and the SN may optimize the CPC based on the CPAC failure info.

It is noted that optimization of the CPAC may include measurement setting (measurement configuration) for the UE 200, such as contents of an execution condition, and selection of the candidate PSCell(s).
Indication indicating CPA or CPC
timeSinceCPACReconfig
timeSinceCPACReconfig may be defined as follows.

In case of CPA/CPC failure, this field is used to indicate the time elapsed between the initiation of the last conditional reconfiguration execution towards the target PSCell cell and the reception of the latest conditional reconfiguration. In case of radio link failure of SCG, this field is used to indicate the time elapsed between the radio link failure of SCG and the reception of the latest conditional reconfiguration.

C-RNTI in MN and/or C-RNTI in SN

The C-RNTI in MN is a C-RNTI for the UE 200 set by the MN, and the C-RNTI in SN is a C-RNTI for the UE 200 set by the SN. As a result, the UE 200 that has transmitted the CPAC failure info can be identified.

### (3.3) Second Operation Example

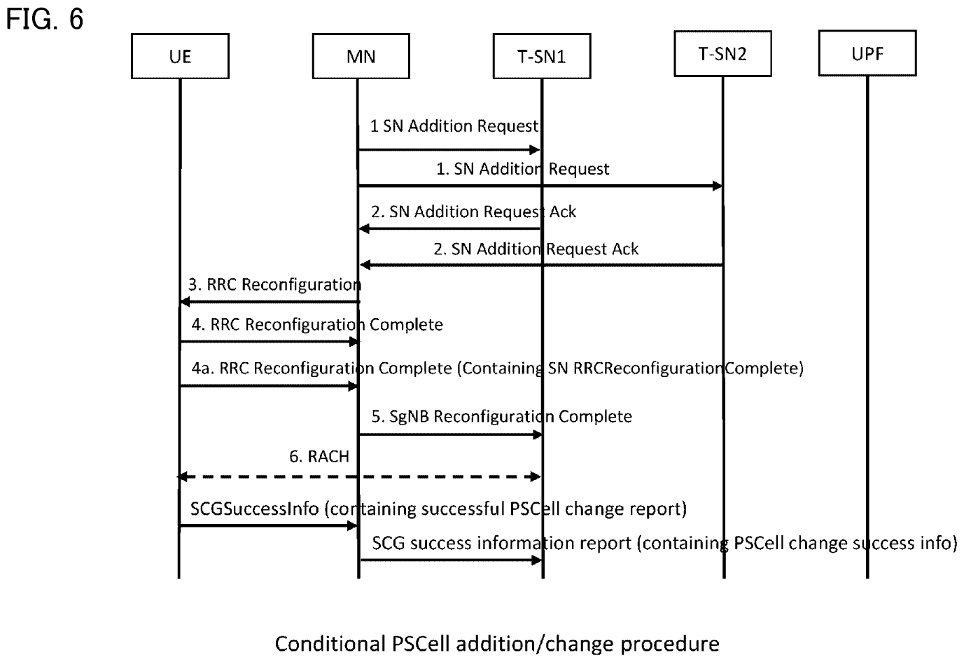

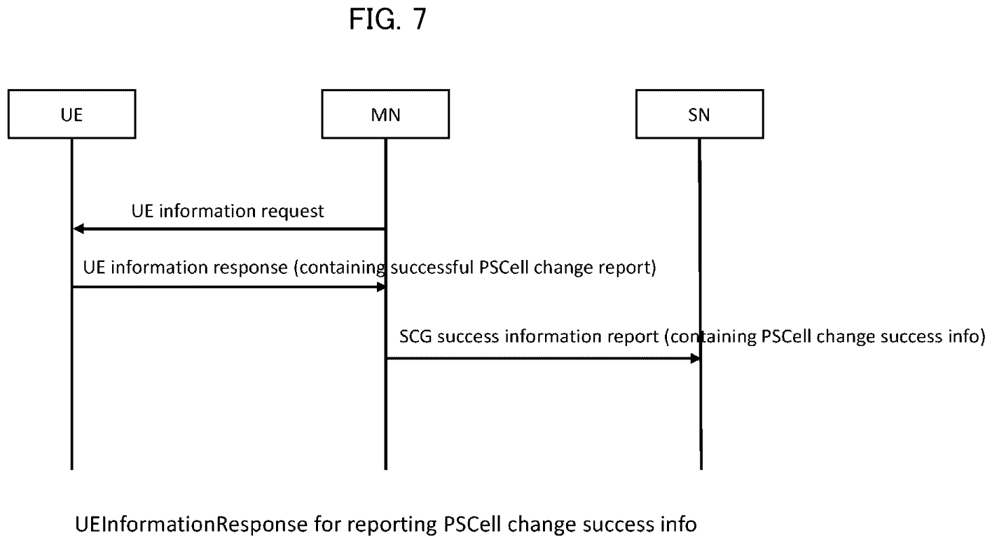

FIG. 6 illustrates a CPAC success report sequence example (using SCGSuccessInfo) according to a second operation example. FIG. 7 illustrates a CPAC success report sequence example (using UE information response) according to the second operation example.

As illustrated in FIGS. 6 and 7, the UE 200 may transmit, to the network, specifically, the MN, the SCGSuccessInfo or the UE information response including the successful PSCell change report. As illustrated in FIG. 6, the UE 200 may transmit the SCGSuccessInfo after receiving the RRC Reconfiguration Complete (containing SN RRCReconfigurationComplete) or after transmitting the RACH. When the RACH (random access procedure) is successful, the UE 200 may transmit the SCGSuccessInfo at any timing after the success. Alternatively, the UE 200 may transmit the SCGSuccessInfo in response to the transmission request of the SCGSuccessInfo from the network.

The successful PSCell change report (and the PSCell change success info) may include the following information (execution information).

Indication that Can Distinguish MN Initiated CPA/CPC or SN Initiated CPC

For example, a type of execution condition associated with the PSCell in which the CPA or the CPC succeeds may be included. Specifically, an indication that is set by condExecutioncond (refer to 3GPP TS38.331) or that is set in condExecutionCondSCG may be included.

Execution Condition Associated with Cell in which CPAC Fails

Specifically, condeventA3, condeventA4, condeventA5, condEventD1, condEventT1 (refer to 3GPP TS38.331) may be included.

Alternatively, CondReconfigId associated with a cell in which the CPAC has succeeded may be included. The MN may determine, based on the reported CondReconfigId, that the condExecutioncond or the condExecutionCondSCG has been set.

### CondReconfigId Associated With Unexecuted Candidate PSCell(s)

In the case of the MN initiated CPA/CPC, since the measurement by the UE 200 is set by the MN, the MN may optimize the CPAC based on SCGFailureInfo (or UE information response). In the case of the SN initiated CPC, since the measurement by the UE 200 is set by the SN, the CPAC failure info is transmitted from the MN to the SN via Xn-AP, and the SN may optimize the CPC based on the CPAC failure info.

timeSinceCPACReconfig

timeSinceCPACReconfig may be defined as follows.
This field is used to indicate the time elapsed between the initiation of the e last conditional reconfiguration execution towards the target PScell and the reception of the latest conditional reconfiguration for this target PScell.
Indication indicating CPA or CPC
Used RACH resource information (for example, RA-InformationCommon)
successful PSCell change report cause (t304-cause, t310-cause, and t312-cause)

t304, t310, and t312 indicate types of timers and are specified in 3GPP TS38.331.
Source PSCell ID/measurement quality (RSRP (Reference Signal Received Power), RSRQ (Reference Signal Received Quality), SINR (Signal-to-Interference plus Noise power Ratio))
Target PSCell ID/measurement quality (RSRP, RSRQ, SINR)
Neighbour PSCell/Candidate PSCell ID/measurement quality (RSRP, RSRQ, SINR)
Location Information of the UE 200
C-RNTI in MN and/or C-RNTI in SN

In addition, the UE 200 may hold a successful PSCell change report therein. In this case, the holding (retention time, number of retained reports, and the like) of the successful PSCell change report may be controlled using a variable (VarSuccessfulPScellChangeReport (provisional name)). Since it is not necessary for the UE 200 to immediately report the successful PSCell change report to the network, the UE may store the successful PSCell change report in the variable VarSuccessfulPScellChangeReport. The UE 200 preferably notifies the network that the successful PSCell change report is held. When the information is necessary, the network may request the UE 200 to report the information.

The holding of the successful PSCell change report may be notified to the network by including the successful PSCell change report or including the information that the SCGSuccessInfo is available, in the UE-MeasurementAvailable IE in the next message.
RRCReconfigurationComplete
RRCSetupComplete
RRCReestablishmentComplete
RRCResumeComplete

In addition, as illustrated in FIGS. 6 and 7, the MN may transmit SCG success information report including the PSCell change success info via XnAP.

In a case where a report form (report config) of the SCGSuccessInfo is set in advance by the network, the UE 200 may transmit the SCGSuccessInfo after the CPAC succeeds. When the report form (report config) is not set, the UE 200 may transmit the SCGSuccessInfo in response to an instruction or a request from the network. As a result, transmission of unnecessary SCGSuccessInfo can be reduced, which can contribute to effective use of resources.

### (4) Action and Effect

According to the above-described embodiments, the following action and effect can be obtained. Specifically, when the CPAC fails, the UE 200 can transmit to the network, the SCGFailureInfo or the UE information response including CPAC failure info. In addition, when the CPAC is successful, the UE 200 can transmit to the network, the SCGSuccessInfo or the UE information response including the successful PSCell change report. The CPAC failure info and the successful PSCell change report include an indication that can distinguish the MN initiated CPA/CPC or the SN initiated CPC, and the like.

Therefore, the network can distinguish the type of CPAC when the CPAC succeeds or fails. Thus, in the case of the MN initiated CPA/CPC, the MN can optimize the CPAC, specifically, the contents of the Measurement configuration, based on the CPAC failure info and/or the successful PSCell change report. On the other hand, in the case of the SN initiated CPC, the MN transmits the CPAC failure info and/or the successful PSCell change report to the SN, and the SN can optimize the CPAC based on the CPAC failure info and/or the successful PSCell change report.

In addition, by using the timeSinceCPACReconfig, a time from when the UE 200 receives setting of the CPAC from the network to when the CPAC succeeds or fails can be reported, so that it is expected to be useful for optimization of the CPAC.

Further, the CPAC failure info and the successful PSCell change report may include a C-RNTI (in MN or SN) allocated to the UE 200. As a result, the UE 200 is easily and reliably associated with the CPAC failure info and the successful PSCell change report, and is expected to be further useful for optimization of the CPAC.

### (5) Other Embodiments

Although the embodiment has been described above, it is obvious to those skilled in the art that various modifications and improvements can be made without being limited to the description of the embodiment.

For example, in the above-described embodiment, the EN-DC in which the MN is the eNB and the SN is the gNB has been described as an example, but another DC may be used as described above. Specifically, it may be an NR-DC in which the MN is a gNB and the SN is a gNB, or an NE-DC in which the MN is a gNB and the SN is an eNB.

Furthermore, in the above-described embodiment, the conditional PSCell addition/change has been mainly described as an example, but the same operation as the above-described operation example may be applied to a Conditional Handover (CHO) or a Conditional SCG change.

In the above description, configure, activate, update, indicate, enable, specify, and select may be read interchangeably. Similarly, link, associate, correspond, and map may be read interchangeably, and allocate, assign, monitor, and map may also be read interchangeably.

Furthermore, specific, dedicated, UE-specific, and UE-individual may be read interchangeably. Similarly, common, shared, group-common, UE-common, and UE-shared may be read interchangeably.

Note that the block diagrams (FIG. 2 and FIG. 3) that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit)”, a “transmitter”, and the like. The method for implementing each component is not particularly limited as described above.

The eNB 100A, the gNB 100B, and the UE 200 (apparatuses) which are described above may function as a computer that executes the processes of the radio communication method of the present disclosure. FIG. 8 is a diagram to illustrating an example of a hardware structure of the apparatuses. As illustrated in FIG. 8, the apparatuses may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a unit, and so on can be interchangeably interpreted. The hardware structure of the apparatuses may be configured to include one or more of apparatuses shown in the drawings, or may be configured not to include part of apparatuses.

Each functional block of the apparatuses (see FIG. 2 and FIG. 3) is implemented by any of hardware elements of the computer apparatus or a combination of the hardware elements.

Each function of the apparatuses is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically Erasable Programmable ROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the method according to one embodiment of the present disclosure.

The storage 1003 is a computer-readable recording medium, and may be constituted with, for example, at least one of an optical disk such as a Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and other appropriate storage media. The storage 1003 may be referred to as “auxiliary storage apparatus”. The above recording medium may be a database including the memory 1002 and/or the storage 1003, a server, or any other appropriate medium.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on.

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the apparatuses may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information in the present disclosure may be implemented by using physical layer signaling (for example, Downlink Control Information (DCI), Uplink Control Information (UCI)), higher layer signaling (for example, RRC signaling, Medium Access Control (MAC) signaling, broadcast information (Master Information Block (MIB), System Information Block (SIB), and so on)), and other signals or combinations of these. Also, RRC signaling may be referred to as an “RRC message”, and can be, for example, an RRC Connection Setup message, an RRC Connection Reconfiguration message, and so on.

The aspects/embodiments illustrated in the present disclosure may be applied to Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate systems, next-generation systems that are enhanced based on these, or combinations of these. A plurality of systems may be combined (for example, a combination of at least one of LTE and LTE-A, and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Operations which have been described in the present disclosure to be performed by a base station may, in some cases, be performed by an upper node of the base station. In a network including one or a plurality of network nodes with the base station, it is clear that various operations that are performed to communicate with the terminal can be performed by the base station, one or more network nodes (for example, MME, S-GW, and so on may be possible, but these are not limiting) other than the base station, or combinations of these. According to the above, a case is described in which there is a single network node other than the base station. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc. ) or wireless technologies (infrared, microwave, etc.), at least one of these wired line technologies or wireless technologies is included within the definition of the transmission medium.

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and a term required for understanding of the present specification may be replaced by a term having the same or similar meaning. For example, at least one of a channel or a symbol may be a signal (signaling). Further, a signal may be a message. Further, the Component Carrier (CC) may be referred to as a carrier frequency, cell, frequency carrier, or the like.

As used in the present disclosure, the terms “system” and “network”are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g. PUCCH, PDCCH) and information elements may be identified by any suitable names, the various names assigned to these various channels and information elements are not used as limitations.

In the present disclosure, the terms such as a “Base Station (BS)”, a “radio base station”, a “fixed station”, a “NodeB”, an “eNB (eNodeB)”, a “gNB (gNodeB)”, an “access point”, a “transmission point”, a “reception point”, a “transmission/reception point”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

The base station can accommodate one or a plurality of (for example, three) cells (also called sectors). When the base station accommodates a plurality of cells, the entire coverage area of the base station can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of the base station and a base station subsystem that provides communication Services within this coverage.

In the present disclosure, the terms “Mobile Station (MS)”, “user terminal”, “User Equipment (UE)”, and “terminal” may be used interchangeably.

A mobile station may be referred to as a “subscriber station”, a “mobile unit”, a “subscriber unit”, a “wireless unit”, a “remote unit”, a “mobile device”, a “wireless device”, a “wireless communication device”, a “remote device”, a “mobile subscriber station”, an “access terminal”, a “mobile terminal”, a “wireless terminal”, a “remote terminal”, a “handset”, a “user agent”, a “mobile client”, a “client”, or some other appropriate terms in some cases.

At least one of the base station and the mobile station may be referred to as a “transmitting apparatus”, a “receiving apparatus”, a “radio communication apparatus”, and so on. Note that at least one of the base station and the mobile station may be a device mounted on a moving object, a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of the base station and the mobile station also includes an apparatus which does not necessarily move during communication operation. For example, at least one of the base station and the mobile station may be an Internet of Things (IoT) device such as a sensor.

Furthermore, the base station in the present disclosure may be interpreted as a user station (user terminal, the same applies hereinafter). For example, each aspect/embodiment of the present disclosure may be applied to the structure that replaces a communication between the base station and the user station with a communication between a plurality of user stations (for example, which may be referred to as “Device-to-Device (D2D)”, “Vehicle-to-Everything (V2X)”, and the like). In this case, the user stations may have the functions of the base station described above. The words such as “uplink” and “downlink” may be interpreted as the words corresponding to the terminal-to-terminal communication (for example, “sidelink”) . For example, an uplink channel, a downlink channel and so on may be interpreted as a sidelink channel.

Likewise, the user station in the present disclosure may be interpreted as the base station. In this case, the base station may have the functions of the user station.

A radio frame may be constituted of one or a plurality of frames in the time domain. Each of one or a plurality of frames in the time domain may be referred to as a “subframe”. Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a SubCarrier Spacing (SCS), a bandwidth, a symbol length, a cyclic prefix length, a Transmission Time Interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols less than the number of slots. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, the base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIS (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot”, or the like. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot”and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “SubCarrier Group (SCG)”, a “Resource Element Group (REG)”, a “PRB pair”, an “RB pair”and so on.

Furthermore, a resource block may be constituted of one or a plurality of Resource Elements (REs). For example, one RE may correspond to a radio resource field of one subcarrier and one symbol.

A Bandwidth Part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or coupling between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

A reference signal may be abbreviated as an “RS”, and may be referred to as a “pilot”, depending on which standard applies.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of”and “at least on the basis of”).

“Means” included in the configuration of each of the above apparatuses may be replaced by “parts”, “circuits”, “devices”, etc.

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present specification is not intended to be an “exclusive or”.

In the present disclosure, where an article is added by translation, for example “a”, “an”, and “the”, the disclosure may include that the noun following these articles is plural.

As used herein, the term “determining” may encompasses a wide variety of actions. For example, “determining” may be regarded as judging, calculating, computing, processing, deriving, investigating, looking up, search inquiry (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing and the like. That is, “determining” may be regarded as a certain type of action related to determining. Furthermore, “determining” may be regarded as “assuming”, “expecting”, “considering”, and the like.

In this disclosure, the term “A and B are different” may mean “A and B are different from each other”. It should be noted that the term “A and B are different” may mean “A and B are different from C”. Terms such as “separated” or “combined” may be interpreted in the same way as the above-described “different”.

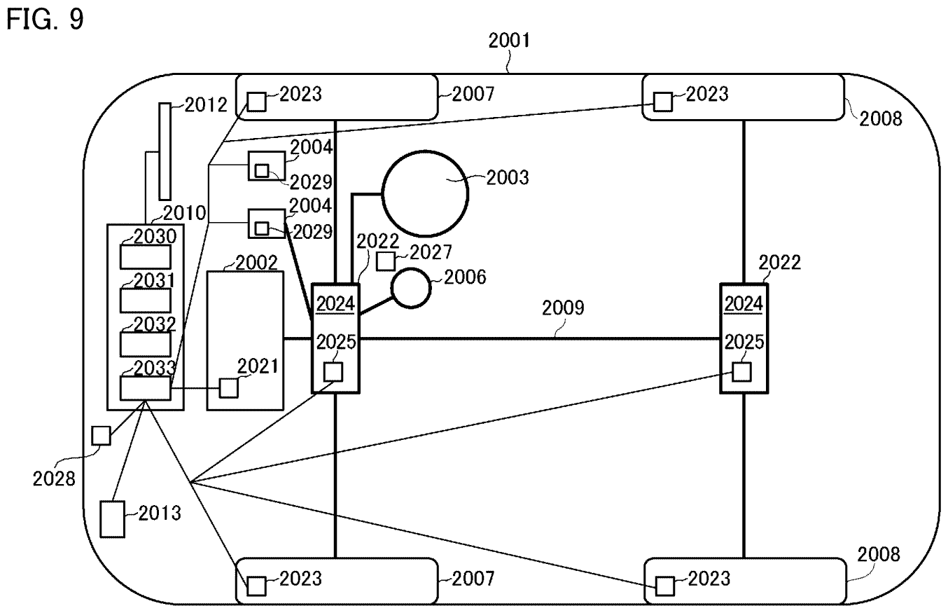

FIG. 9 illustrates an example of a configuration of a vehicle 2001. As illustrated in FIG. 11, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021 to 2029, an information service unit 2012, and a communication module 2013.

The drive unit 2002 may include, for example, an engine, a motor, and a hybrid of an engine and a motor.

The steering unit 2003 includes at least a steering wheel and is configured to steer at least one of the front wheel and the rear wheel, based on the operation of the steering wheel operated by the user.

The electronic control unit 2010 includes a microprocessor 2031, a memory (ROM, RAM) 2032, and a communication port (10 port) 2033. The electronic control unit 2010 receives signals from the various sensors 2021 to 2027 provided in the vehicle 2001. The electronic control unit 2010 may be referred to as an ECU (Electronic control unit).

The signals from the various sensors 2021 to 2028 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 1 by using information obtained from the external device through the communication module 2013 or the like.

support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, and an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 1 via a communication port. For example, the communication module 2013 transmits and receives data via a communication port 2033, to and from the drive unit 2002, the steering unit 2003, the accelerator pedal 2004, the brake pedal 2005, the shift lever 2006, the front wheel 2007, the rear wheel 2008, the axle 2009, the microprocessor 2031 and the memory (ROM, RAM) 2032 in the electronic control unit 2010, and sensors 2021 to 2028 provided in the vehicle 1.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 transmits the current signal from the current sensor, which is input to the electronic control unit 2010, to external devices through radio communication. In addition, the communication module 2013 transmits to external devices through radio communication, the front or rear wheel rotation signal acquired by the revolution sensor 2022, the front or rear wheel pneumatic signal acquired by the pneumatic sensor 2023, the vehicle speed signal acquired by the vehicle speed sensor 2024, the acceleration signal acquired by the acceleration sensor 2025, the stepped-on accelerator pedal signal acquired by the accelerator pedal sensor 2029, the stepped-on brake pedal signal acquired by the brake pedal sensor 2026, the operation signal of the shift lever acquired by the shift lever sensor 2027, and the detection signal, acquired by the object detection sensor 2028, for detecting an obstacle, a vehicle, a pedestrian, and the like.

The communication module 2013 receives various types of information (traffic information, signal information, inter-vehicle information, etc.) transmitted from the external devices and displays the received information on the information service unit 2012 provided in the vehicle. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021 to 2028, etc., mounted in the vehicle 2001.

### (Supplementary Note)

The above-described disclosure may be described as follows.

A first feature is a terminal including: a control unit that controls execution of an addition or change procedure for a secondary cell; and a transmitting unit that transmits a message to a network when the addition or change procedure succeeds or fails, the message including therein a type of the addition or change procedure, and execution information indicating that the addition or change procedure is initiated by a master node or a secondary node.

A second feature is the transmitting unit in the first feature that transmits, when the addition or change procedure fails, the message including therein an execution condition of the addition or change procedure associated with the secondary cell for which the addition or change procedure fails.

A third feature is the transmitting unit in the first or second feature that transmits the message including therein an elapsed time from a start of the addition or change procedure.

A fourth feature is the transmitting unit in the first to third features that transmits the message including therein identification information of the terminal.

A fifth feature is the transmitting unit in the first to fourth features that transmits, when the addition or change procedure fails, the message including therein information on a candidate secondary cell other than the secondary cell for which the addition or change procedure fails.

A sixth feature is the transmitting unit in the first to fifth features that transmits, when the addition or change procedure succeeds, the message according to a setting of whether transmission of the execution information is necessary.

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### EXPLANATION OF REFERENCE NUMERALS

10 radio communication system
20 E-UTRAN
30 NG-RAN
40 UPF
100A eNB
100B gNB
110 radio communication unit
120 RRC/Xn processing unit
130 DC processing unit
140 control unit
200 UE
210 radio communication unit
220 RRC processing unit
230 DC processing unit
240 control unit
1001 processor
1002 memory
1003 storage
1004 communication apparatus
1005 input apparatus
1006 output apparatus
1007 bus
2001 vehicle
2002 drive unit
2003 steering unit
2004 accelerator pedal
2005 brake pedal
2006 shift lever
2007 front wheel
2008 rear wheel
2009 axle
2010 electronic control unit
2012 information service unit
2013 communication module
2021 current sensor
2022 revolution sensor
2023 pneumatic sensor
2024 vehicle speed sensor
2025 acceleration sensor
2026 brake pedal sensor
2027 shift lever sensor
2028 object detection sensor
2029 accelerator pedal sensor
2030 driving support system unit
2031 microprocessor
2032 memory (ROM, RAM)
2033 communication port

1. A terminal comprising:
a control unit that controls execution of an addition or change procedure for a secondary cell; and
a transmitting unit that transmits a message to a network when the addition or change procedure succeeds or fails, the message including therein a type of the addition or change procedure, and execution information indicating that the addition or change procedure is initiated by a master node or a secondary node.

2. The terminal according to claim 1, wherein the transmitting unit transmits, when the addition or change procedure fails, the message including therein an execution condition of the addition or change procedure associated with the secondary cell for which the addition or change procedure fails.

3. The terminal according to claim 1, wherein the transmitting unit transmits the message including therein an elapsed time from a start of the addition or change procedure.

4. The terminal according to claim 1, wherein the transmitting unit transmits the message including therein identification information of the terminal.

5. The terminal according to claim 1, wherein the transmitting unit transmits, when the addition or change procedure fails, the message including therein information on a candidate secondary cell other than the secondary cell for which the addition or change procedure fails.

6. The terminal according to claim 1, wherein the transmitting unit transmits, when the addition or change procedure succeeds, the message according to a setting of whether transmission of the execution information is necessary.

7. A radio communication method comprising steps of:
executing, by a terminal, an addition or change procedure for a secondary cell; and
transmitting, by the terminal, a message to a network when the addition or change procedure succeeds or fails, the message including therein a type of the addition or change procedure, and execution information indicating that the addition or change procedure is initiated by a master node or a secondary node.
